(19) United States
(12) Patent Application Publication
(10) Pub. No.: US 2017/0053768 A1
(43) Pub. Date: Feb. 23, 2017

(54) Hooked Fuse Barrel

(71) Applicant: Michael J. Guillery, Live Oak, FL (US)

(72) Inventor: Michael J. Guillery, Live Oak, FL (US)

(21) Appl. No.: 14/828,826

(22) Filed: Aug. 18, 2015

(51) Int. Cl. H01H 85/175; H01H 85/17

(52) U.S. Cl. CPC H01H 85/175; H01H 85/17

(57) ABSTRACT

A hooked fuse barrel, illustrates a cutout that mounts conventionally on utility poles includes an elongated fusible link contained within a fiber glass fuse barrel; a sieve attached to the upper end of the fuse barrel includes a pull ring which attaches to and extends outwardly from the said sleeve; a fiber glass hook is attached and extends outwardly engage with the switch device. Advantageously, a hooked fuse barrel selectively receiving a long stick for disengaging the fuse body from the connection assembly and cut the amount of work, time and effort needed to replace the fuse on the top of electrical transformer on electrical poles.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to an improved fuse barrel and, more particularly, to an improved hooked fuse barrel, which is less expensive to manufacture than prior art fuse barrels, but which exhibits improved operating performance notwithstanding the decrease in expense thereof.

(2) Background of the Invention

Commercial and residential electrical powers are distributed through electric cables which are supported along a series of power poles. Many of the poles are strategically mounted with interrupt assemblies or vertically mounted cutout assemblies. The cutout switch can be used to interrupt a connection to the transmission line, and may be connected to a transformer or another portion of the power distribution network.

Vertical cutouts include a combined switch and fuse element, which is pivotally mounted at one end in a hinge bracket usually located at the lower end of the cutout. The fuse element is typically a cylindrical fuse body that encases a fuse that connects electrically at distal ends with the electrical power lines. At its other end, the switch has a rounded cap that can be engaged in a recess of a contact plate, which is under spring pressure. The switch pivots with respect to the lower hinge bracket mounting, and the combined switch and fuse element constitutes a pivotal switch lever. Many cutout switches move to drop out position after a fuse blows. Thus, the fuse that needs replacement is readily identified such as by a linesman driving along a roadway. Also, many of the devices may be operated manually by a lineman to interrupt the electrical circuit.

The switch and fuse body combination are typically fitted with a structural feature designed for cooperation with a handling tool, commonly referred to as hook stick. These handheld hook sticks are typically 30 to 40 feet in length. The hook stick is operated by a utility worker either on a pole, in a bucket truck, or on the ground. The typical structural feature that the hook stick cooperates with to operate the lever is a pull ring that extends from the end of the lever, the utility lineman inserts the hook stick into the pull ring and using the hook stick to actuate the lever by pressing against the pull ring with the hook stick.

The prior art hook stick operated levers are difficult and cumbersome to operate because of the inadequate structural features provided for actuating the switch levers. Inserting the hook stick into the typical ring requires skill and patience. The difficulty of inserting the hook stick into the ring is further complicated by the conditions in which electrical system faults generally occur. High winds and lightning are leading causes of system faults. Therefore, a need to operate a cut out switch often arises during poor weather and at nighttime. Placing the hook stick into a small ring at the top of a utility pole is even more arduous a task in wet, windy, and dark conditions which may cause numerous failed attempts and become time consuming. Time is of the essence in restoration of electrical power. Moreover, safety of utility personnel is a significant concern. Failed attempts to insert a hook stick into a pull ring increase the personnel's exposure to weather conditions or electrical hazards. The prior art fails to address these problems associated with the hook stick operated cutout switches.

Various prior art discloses a hook sticks attempts have been made to solve the above-mentioned problems such as those found in U.S. Pat. No. 6,512,442 to Taylor Maddox Technical, inc; U.S. Pat. No. 8,517,757 to Thomas A. Unger; U.S. Pat. No. 7,786,841 to John Kesting; U.S. Pat. No. 5,532,668 to Fennell; Robert B; U.S. Pat. No. 2,362,314 to Line Material Co; U.S. Pat. No. 2,204,299 to Railway & industrial Eng. Co.

Accordingly, it is seen that a need remains for improved operational controllers of removable switches or fuse bodies on overhead mounted electrical distribution devices It is to the provision of such therefore that the present invention is directed.

### SUMMARY OF THE INVENTION

The present invention solves the deficiencies in prior art overhead mounted switches, fuse bodies, and cut out devices operated by long sticks, by providing an improved hooked fuse barrel attached to electrical distribution equipment mounted on poles of electrical distribution systems.

The fuse barrel comprises a fiberglass hook assembly engaging with first distal end of a fuse body. The hooks are acting as a grab member and a restoring member. The grab member attached to the fuse body near the first distal end at an angle laterally there from and defines a selectively receiving a long stick for disengaging the fuse body from the connection assembly.

An additional object of the present invention is to provide a hooked fuse barrel, which is painted by fluorescent orange.

A further object of the present invention is to provide a hooked fuse barrel, which is covered by reflecting tape for clear night vision.

A further object of the present invention is to provide a hooked fuse barrel, which is covered by a rubber coating.

In another aspect, the present invention provides a method of operating hooked fuse barrel attached to electrical distribution equipment mounted on poles of electrical distribution systems, comprising the steps of:

(a) Engaging a long stick with a hook attached to a first end of a fuse body that is engaged to a connection assembly of a fuse barrel; and

(b) Moving the long stick to cause the first end of the fuse body to move outwardly from engagement with the connection assembly.

Finally, it is a general goal of the invention to provide improved elements and arrangements thereof in an apparatus for the purposes described which is dependable and fully effective in accomplishing its intended purposes.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a hooked fuse barrel with a prior art pull ring feature,

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

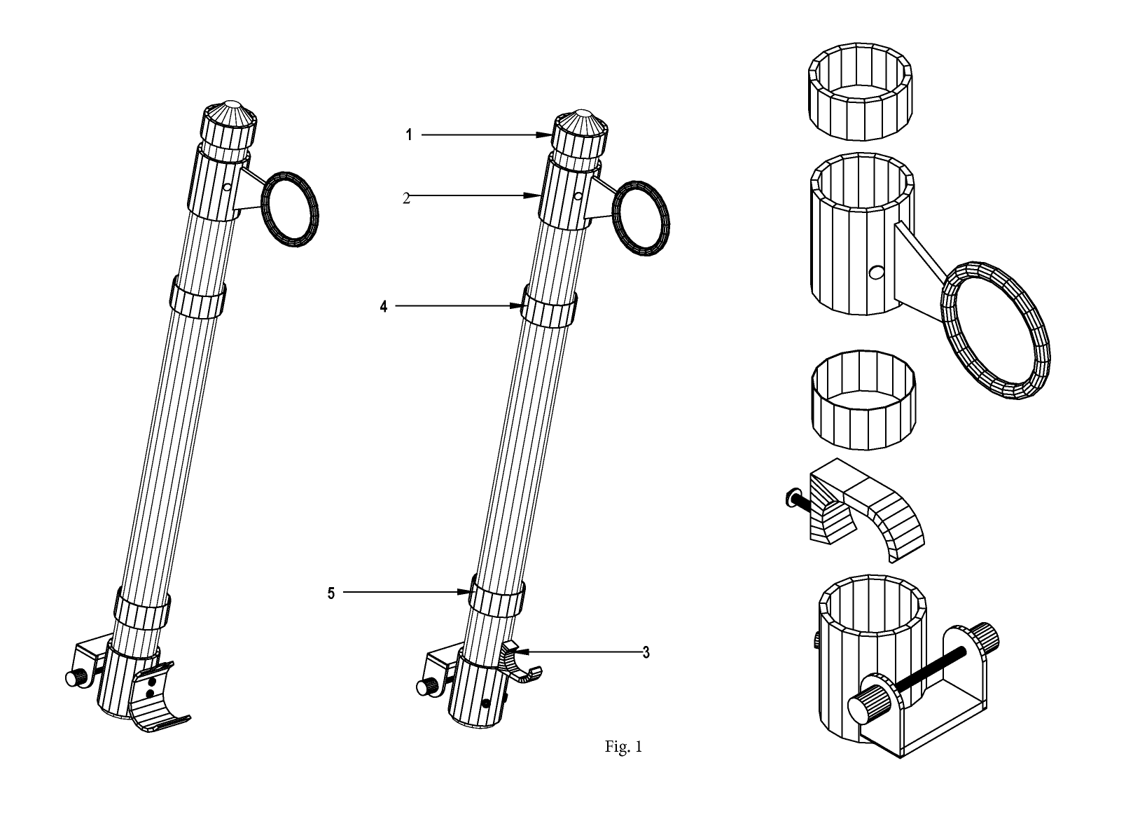

FIG. 1 depicts a hooked fuse barrel, which illustrates a cutout that mounts conventionally on utility poles. The hooked fuse barrel includes an elongated fusible link contained within a fiberglass fuse barrel. The function of the fusible link in cutout assemblies is well known and does not form a part of the present invention. A sleeve 1 attached to the upper end of the fuse barrel, also known as a ferrule, includes a pull ring 2 which attaches to and extends outwardly from the sleeve. The long stick goes into the opposite end toward to the pull ring. The hook is designed to be hooked on neutral wire to take old barrel down and rotate over to barrel hanging on neutral wire and set it in bottom of switch and close. To operate the device the long stick is opened and closed once The hook is positioned on the same side as pull ring at bottom of barrel curling up toward pull ring.

The long stick, allowing a lineman to access the fusible link by pulling down on the pull ring with the long stick to effectuate the temporary removal of the fuse holder from the cutout assembly. Along with said assembly a fiberglass hook 3 is attached and extends outwardly, which is part of the present invention.

In another embodiment the fiber glass fuse barrels are coated with the rubber coating.

Furthermore, a reflective tape 4, 5 is Positioned where fuse barrels are hanging down in blown position which can illuminate it in the night and provides proper visibility to the lineman for easy insertion of the long stick.

Referring further to FIG. 1, the hooked fuse barrel of the present invention is provided which is covered with the fluorescent paint for better visibility. Also, a pull ring is made of around 1% in diameter, which effectively provides both a target and a cooperating means for the engagement of the functional end of a long stick.

Method of operating hooked fuse barrel attached to electrical distribution equipment mounted on poles of electrical distribution systems, comprising the steps of:

(a) Engaging a long stick with a hook attached to a first end of a fuse body that is engaged to a connection assembly of a fuse barrel; and

(b) Moving the long stick to cause the first end of the fuse body to move outwardly from engagement with the connection assembly.

Accordingly, the present invention provides an improved and effective structure that makes the operation of long sticks easier and faster while reducing the level of skill and patience necessary to place long sticks into pull ring actuators. The present invention as disclosed herein results in an improved switch arrangement that provides operational control of cutout switches or fuse bodies by long stick handling tools. The novel structural features of the apparatus include a hook member engaged to a connection assembly of a fuse barrel. Further, the present invention is readily installed as a retrofit application to existing installed cutout switches. Once the hook of the present invention is installed, the cutout switch may be operated without finding and placing the long stick into a pull ring. Instead, the improved manipulating apparatus allows a lineman to engage the long stick to the switch of the cutout device by sliding the long stick into the hook, and moving the long stick in the desired direction, to open or close the switch in order to remove or replace a blown fuse in the cutout device. Thus, the switch may be operated with less difficulty and engagement attempts with long sticks with less precision than that needed for inserting long sticks into prior art pull rings.

It is to be understood that the above description is intended to be illustrative, and not restrictive, or example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A hooked fuse barrel conventional mountained on utility poles comprising:
an elongated fusible link contained within a fiber glass fuse barrel;
a sieve attached to the upper end of said fuse barrel having a pull ring which attaches to and extends outwardly from the said sleeve; and
a fiber glass hook is attached and extends outwardly engage with the switch device.

2. The hooked fuse barrel of claim 1, wherein said barrels having the rubber coating.

3. The hooked fuse barrel of claim 1, wherein said barrels are covered with the reflector tape.

4. The hooked fuse barrel of claim 1, wherein said hook is covered with the fluorescent paint for better visibility.

5. The hooked fuse barrel of claim 1, wherein said pull ring having 1% in diameter, which effectively provides both a target and a cooperating means for the engagement of the functional end of a long stick.

6. Method of operating hooked fuse barrel attached to electrical distribution equipment mounted on poles of electrical distribution systems, comprising the steps of:
(a) Engaging a long stick with a hook attached to a first end of a fuse body that is engaged to a connection assembly of a fuse barrel; and
(b) Moving the long stick to cause the first end of the fuse body to move outwardly from engagement with the connection assembly.
